(19) United States
(12) Patent Application Publication
(10) Pub. No.: US 2009/0154374 A1
(43) Pub. Date: Jun. 18, 2009

(54) COMMUNICATION OF CONFIGURATION MANAGEMENT NOTIFICATIONS IN A PACKET-SWITCHED NETWORK

(75) Inventor: Mikael JAATINEN, Raisio (FI)

Correspondence Address: YOUNG & THOMPSON, 209 Madison Street, Suite 500, ALEXANDRIA, VA, 22314, US

(73) Assignee: ELEKTROBIT WIRELESS COMMUNICATIONS OY, Oulu (FI)

(21) Appl. No.: 11/955,708

(22) Filed: Dec. 13, 2007

(51) Int. Cl. H04L 12/28

(52) U.S. Cl. 370/254

(57) ABSTRACT

A method and devices are provided for communicating configuration management notifications from a network element to a network manager in a packet-switched network. The configuration information of the network element is stored at different time instants having a time interval therebetween. Two sets of configuration information are compared in order to determine changes between the two time instants. The changes are then transmitted to the network manager through a communication connection by using a file-based configuration protocol.

### TECHNICAL FIELD OF THE INVENTION

The present invention concerns generally the technology of managing configuration of network elements in a packet-switched network. Especially the invention concerns mechanisms for communicating configuration management notifications from such network elements to a network manager when using a file-based configuration protocol.

### BACKGROUND OF THE INVENTION

The Network Configuration Protocol, or NETCONF for short, is a network management protocol that defines mechanisms to install, manipulate and delete the configuration of network elements in a packet-switched network. NETCONF is a file-based configuration protocol that uses an XML (Extensible Markup Language) based data encoding for the configuration data as well as the protocol messages. The essential details of NETCONF are available to the public in the document RFC 4741, published in December 2006 by IETF, where RFC comes from Request For Comments and IETF is Internet Engineering Task Force. Said document is incorporated herein by reference.

According to NETCONF, messaging between a client and a server is based on transfer of XML files. The client encodes an RPC (Remote Procedure Call) in XML and sends it to the server using a connection-oriented session. The server responds with a reply encoded in XML. The contents of both the request and the reply are fully described in XML DTDs (Document Type Definition) and XML schemas, or both, allowing both parties to recognize the syntax constraints imposed on the exchange.

The NETCONF protocol defines mechanisms through which configuration data can be retrieved, and new configuration data can be uploaded and manipulated. The efficiency comes from transferring large volumes of data in one transaction, for example loading of the configuration data in one go. On the other hand, because NETCONF is a file-based protocol, transferring small volumes of data with this technology is inefficient and resource wasting. This inefficiency culminates, for example, when configuration management (CM) notifications from network elements are to be reported. The configuration file overhead is unnecessary large for communicating configuration management notifications per single changes. The same problems also arise with other file-based network management protocols, such as the one specified in the technical specification by the 3rd Generation Partnership Project, known as the 3GPP TS 32.600.

### SUMMARY OF THE INVENTION

It is the main objective of the present invention to reduce or even eliminate prior art problems presented above.

It is an objective of the present invention to enable handling of configuration management notifications in a simple and efficient manner, without overloading the network element, the network through which the notifications are transmitted to the network manager and the network manager itself. In more detail, it is an objective of the invention to provide a method, a network element, a system and a computer program product enabling to report configuration management notifications to a network manager in a packet-switched network when using a file-based configuration protocol.

The objectives of the invention are achieved by communicating configuration management notifications from a network element to a network manager at intervals of a certain time, instead of communicating changes instantly.

According to a first aspect of the invention there is provided a method for communicating configuration management notifications from a network element to a network manager in a packet-switched network. The method comprises storing in the network element a first set of configuration information of the network element at a first time instant, waiting for a time interval, storing in the network element a second set of configuration information of the network element at a second time instant, comparing the first and the second set of configuration information in order to determine changes in the configuration information between the first and the second time instant, and transmitting the changes to the network manager through a communication connection by using a file-based configuration protocol.

According to a second aspect of the invention there is provided a network element for communicating configuration management notifications to a network manager in a packet-switched network. The network element comprises a timer for scheduling operations, the timer having a time interval means for storing configuration information of the network element at time instants scheduled by the timer, means for comparing the stored configuration information in order to determine changes in the configuration information between the time instants, and means for transmitting the changes to the network manager through a communication connection by using a file-based configuration protocol.

According to a third aspect of the invention there is provided a system for communicating configuration management notifications from a network element to a network manager in a packet-switched network. The system comprises at the network element a timer for scheduling operations, the timer having a time interval, means for storing configuration information of the network element at time instants scheduled by the timer, means for comparing the stored configuration information in order to determine changes in the configuration information between the time instants, and means for transmitting the changes to the network manager through a communication connection by using a file-based configuration protocol; and at the network manager means for receiving the changes in configuration information by using a file-based configuration protocol.

According to a fourth aspect of the invention there is provided a computer program product comprising program code means stored on a computer-readable medium for performing a method according to some of the method aspects recited above.

Various embodiments of the invention are described in the depending claims.

### BRIEF DESCRIPTION OF THE DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates a conceptual model of the NETCONF protocol,

FIG. 2 illustrates certain devices and the connections therebetween,

FIG. 3 illustrates the procedure of communicating configuration management notifications according to an embodiment of the invention, and

FIG. 4 illustrates the procedure of communicating configuration management notifications according to another embodiment of the invention.

The exemplary embodiments of the invention presented in this text are not interpreted to pose limitations to the applicability of the appended claims. The verb “to comprise” is used in this text as an open limitation that does not exclude the existence of also unrecited features. The features recited in the depending claims are mutually freely combinable unless otherwise explicitly stated.

### DETAILED DESCRIPTION OF THE INVENTION

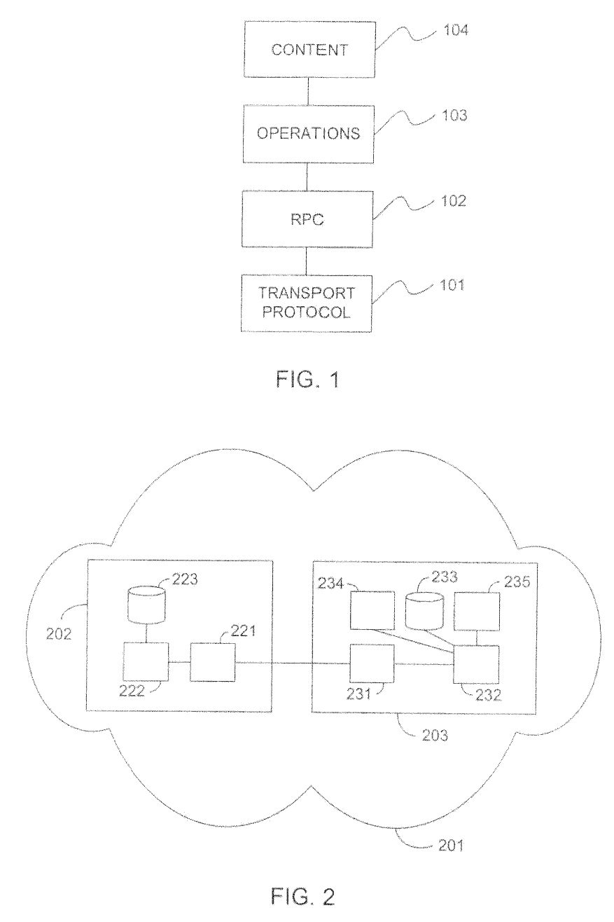

FIG. 1 illustrates, as an example of a file-based configuration protocol, a conceptual model of the NETCONF protocol. According to this model, the protocol is partitioned into four layers. The transport protocol layer 101 provides a communication path between a client and a server. The client can be a network manager or more specifically a script or an application running as a part of the network manager, whereas the server is typically a network element. The terms “client” and “network manager” are used interchangeably in this text, as are the terms “server” and “network element”.

The NETCONF protocol can be layered on any transport protocol 101 that provides the required set of functionality. For example, because the NETCONF protocol requires persistent connections between peers, the transport protocol 101 must provide connection-oriented service. The transport protocol 101 must also provide mechanisms for authentication, data integrity and confidentiality of connections between peers. Connections can be encrypted, for example, in TLS (Transport Layer Security) or SSH (Secure Shell). Furthermore, the transport protocol 101 must provide a mechanism to indicate the session type (client or server).

NETCONF uses an RPC based communication paradigm 102, providing a transport-independent framing mechanism. A NETCONF session is the logical connection between a client (network manager) and a server (network element). The client sends a series of one or more RPC request operations encoded in XML, which cause the server to respond with a corresponding series of RPC replies, also in XML.

NETCONF provides an initial set of operations 103 to manage configurations and retrieve state information, and a number of capabilities that can be used to extend the base. When the session is initiated, NETCONF peers exchange network element capabilities. By a NETCONF capability it is meant a set of functionality that supplements the base NETCONF specification. The capability is identified by a URI (Uniform Resource Identifier).

The configuration information that can be retrieved from a running network element can be separated into two classes, i.e. configuration data and state data. The configuration data is a set of writable data that is required to transform a network element from its initial default state into its current state. State data is additional data on a network element, such as read-only status information and collected statistics. Given the current proprietary nature of the configuration data being manipulated, the specification of this content 104 depends on the NETCONF implementation.

In order to get a network element from an initial operational state into a desired state, configuration data of the network element must be managed, for example, by a network manager over a logical connection between the network element and the network manager. The network element configuration data can also be changed through a local management interface, for example by a user.

Since the network manager typically maintains an up-to-date or almost up-to-date centralized configuration data repository, changes in the configuration data must be reported to the network manager. Typically, these configuration management notifications are reported in real-time for each change in the data. The drawback of a technology utilising a file-based configuration protocol, compared with non-file-based operation and maintenance (O&M) technologies like CORBA (Common Object Request Broker Architecture) and SNMP (Simple Network Management Protocol), is that the configuration file overhead is (too) large for communicating configuration management notifications per single changes. This kind of operation mode results in waste of network resources.

FIG. 2 is a general illustration of the devices taking part in communication of configuration management notifications according to an embodiment of the invention. A network 201 comprises a network manager 202 and a network element 203 which are linked together through the network 201. Only one network element is shown within the network 201; the actual number of network elements can be anything between only one and several thousands. The network 201 is a packet-switched network, such as a TCP/IP (Transmission Control Protocol/Internet Protocol) based communication network. The network manager 202 comprises communicating means 221, processing means 222 and a configuration database 223. The network element 203 comprises communicating means 231, processing means 232, memory means 233, a timer 234 and a local management interface 235.

The task of the network manager 202 is to monitor and administer the network 201, and especially the network element 203 via a suitable file-based network management protocol, e.g. NETCONF. The management protocol defines mechanisms to install, manipulate and delete the configuration of the network element 203. The communicating means 221 of the network manager 202 are used to transmit data to the network element 203 and to receive data from the network element 203. Especially the communicating means 221 are responsible for receiving changes in configuration information of the network element 203. Broadcasting of packets between the network manager 202 and the network element 203 requires a persistent connection between the peers, and thus the transport protocol provides connection-oriented service. The configuration database 223 of the network manager 202 is used to maintain an (almost) up-to-date configuration information of the network element 203. The processing means 222 of the network manager 202 are responsible for the procedures relating to managing configuration of the network element 203, including setting the time interval of the timer 234, updating the configuration database 223 and setting up filters for configuration information of the network element 203 which filters define rules to select which configuration changes are to be transmitted to the network manager 202.

The type of the network element 203 is not limited to a specific type as long as the element provides the essential features according to the invention. An exemplary network element could be a radio base station. The communicating means 231 of the network element 203 are responsible for transmitting data to the network manager 202 and receiving data from the network manager 202. The timer 234 of the network element 203 is used for scheduling operations. The time interval of the timer 234 can be changed or the timer 234 can be switched off. The task of the timer 234 is to provide time intervals at which configuration information of the network element 203 is stored, and changes in the configuration information are reported to the network manager 202. The memory means 233 of the network element 203 are used to store configuration information of the network element 203 at time instants scheduled by the timer 234. The processing means 232 of the network element 203 are used e.g. to compare configuration information of the network element 203, which information has been stored at different time instants, and to manage the filters which have been set up by the network manager 202.

The local management interface 235 of the network element 203 allows local access to configuration information of the network element 203. Through the local management interface 235, a user can manage configuration data and add new features or facilities to the network element. An exemplary local management interface is a CLI (Command Line Interface).

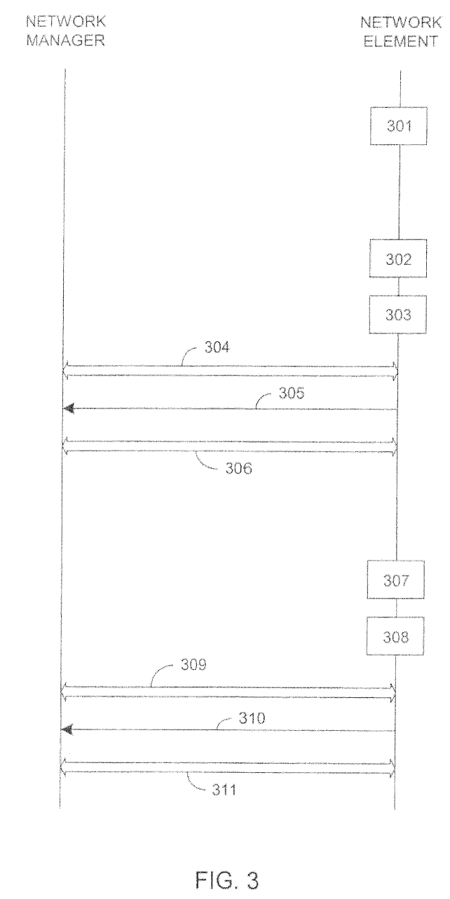

FIG. 3 illustrates the procedure of communicating configuration management notifications according to an embodiment of the invention. At step 301, a first set of configuration information of the network element 203 is stored in the memory means 233 of the network element 203. After a certain time interval, a second set of configuration information of the network element 203 is stored at step 302. Between the first and the second time instant, values of configuration data and state data can change, and new objects can be created. Therefore, the stored sets of configuration information are likely to be different. A timer can be used for generating the time interval and thus scheduling the operations. Typically, the first set of configuration information is stored when the timer starts, and the second set is stored when the timer expires, that is when the determined time interval has passed. A suitable time interval between the time instants depends on the application and can be, for example, in the range of 1 to 5 minutes, 5 to 15 minutes or 15 to 30 minutes.

At step 303, the first and the second set of configuration information are compared in order to determine changes in the configuration information between the first and the second time instant. These changes will then be reported to the network manager 202.

At step 304, a connection is established between the network manager 202 and the network element 203. During the connection establishment, capabilities of the peers are advertised in messages. In NETCONF, which is a file-based configuration protocol, messaging between the peers is based on transfer of XML files. The NETCONF protocol uses an RPC based communication model, that is, NETCONF peers use <rpc> and <rpc-reply> elements, to provide transport protocol-independent framing of NETCONF requests and responses. Based on this communication model, at step 305, the changes in the configuration information are transmitted from the network element 203 to the network manager 202. After the transmission the connection is released at step 306.

At step 307, a third set of configuration information of the network element 203 is stored. The time interval between the second and the third time instant can be the same as between the first and the second or it can be configured to be different. At step 308, the second and the third set of configuration information are compared in order to determine the differences between these two sets. For communicating the changes to the network manager 202, a connection is established at step 309, changes are transmitted at step 310, and then the connection is released at step 311. The principle of steps 307-311 can be repeated as many times as necessary. An advantage of communicating configuration management notifications at intervals of certain times is that toggling state changes caused e.g. due to software malfunction can be filtered.

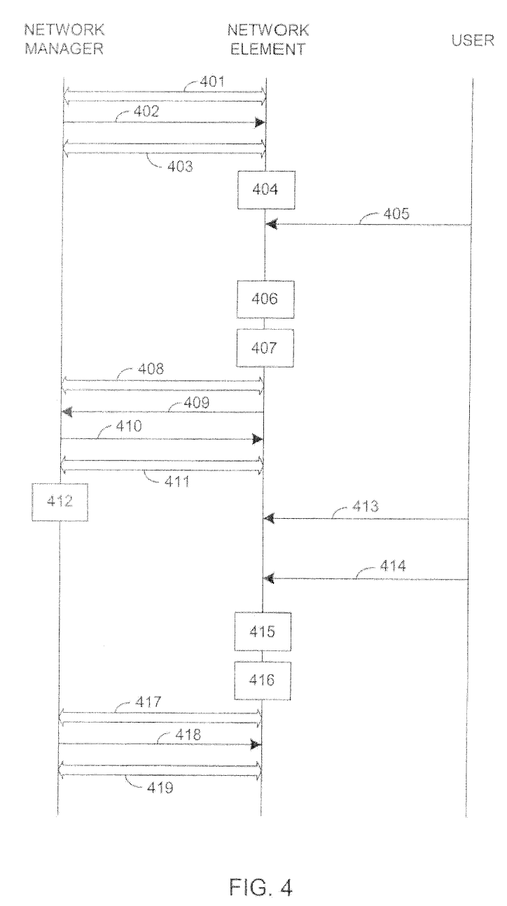

FIG. 4 illustrates the procedure of communicating configuration management notifications according to another embodiment of the invention. At step 401, a connection is established between the network manager 202 and the network element 203. The network manager 202 initialises the timer 234 by setting a time interval. This is performed at step 402. The connection between the manager 202 and the element 203 is released at step 403.

During this session, the network manager 202 could upload new configuration data to the network element 203. The network manager 202 could also set up one or more filters for the configuration information of the network element 203. These filters define rules based on which changes in configuration information are either communicated to the network manager 202 or not. For example, a rule could say that a change in a configuration parameter is not reported to the network manager 202 if the network manager 202 itself has initiated this configuration change. A filter can be valid for a certain predetermined time, for example until the timer 234 expires. Alternatively, a filter can be valid until it is separately disabled. The same filter can be defined as effective for a single network manager 202 or a group of network managers.

At step 404, a first set of configuration information of the network element 203 is stored in the memory means 233 of the network element 203. Typically, the first set of configuration information is stored when the timer 234 starts. In case there is a possibility that the configuration database 223 of the network manager 202 is not up-to-date when the first set of configuration information is stored, the configuration database 223 should be updated by communicating the configuration information to the network manager 202.

During the predetermined time interval, configuration information of the network element 203 can change. At step 405, a user accesses the network element 203 through the local management interface 235. The user manages the configuration information so that values of configuration data and/or state data are changed, for example by adding or removing features or facilities to the network element 203. An exemplary local management interface is a CLI. At step 406, a second set of configuration information of the network element 203 is stored, and the timer 234 is restarted. After storing the second set, the first and the second set of configuration information are compared at step 407 in order to determine changes in the configuration information between the first and the second time instant.

At step 408, a connection is established between the network manager 202 and the network element 203, and then the changes in the configuration information are transmitted to the network manager 202 at step 409. If filters have been set, it is checked before the transmitting step whether it is permitted to communicate all or just some of the configuration changes to the network manager 202. It is even possible that none of the changes are allowed to be communicated to the network manager 202.

During the established session, the time interval of the timer 234 is changed. This change is performed by the network manager 202 through the communication connection at step 410. At step 411, the connection is released. After the changes in the configuration information of the network element 203 have been communicated to the network manager 202, the configuration database 223 of the network manager 202 is updated. This is accomplished at step 412.

At step 413, the user changes some configuration information, but then at step 414 the user restores the network element 203 into a state that preceded step 413. After step 414, a third set of configuration information of the network element 203 is stored at step 415. Since at step 410 the time interval of the timer 234 was changed, the time interval between the second and the third time instant is different than the time interval between the first and the second time instant. At step 416, the second and the third set of configuration information are compared in order to determine changes in the configuration information between the second and the third time instant. Assuming that no other changes have occurred, there are no changes between the second and the third set of configuration information. Therefore, a connection will not be established between the network manager 202 and the network element 203 for the purpose of communicating management notifications.

At step 417, a connection is established between the network manager and the network element in order to switch off the timer of the network element at step 418. Then the connection is released at step 419.

According to an embodiment of the invention, there can be several network managers in one or several packet-switched networks which network managers can receive configuration management notifications from one or several network elements. For example, when there is a plurality of similar network elements connected to each other in the same system, it may be possible that the different network managers do not need all the configuration notifications. Thus, according to the present invention, it is possible to switch the configuration management notifications on or off so that some network managers receive notifications while others do not. Or according to another embodiment, this is arranged so that certain network managers are immune to certain configuration information. This information can be conveyed, for example, in a header field of a configuration message or set in the network element. In case, where there are several network managers controlling a network element, and one of those network managers updates the configuration data of the network element, this method can be used to update (“mirror”) the configuration data in the databases of the other network managers also.

Being computer-related, it can be appreciated that the components disclosed herein may be implemented in hardware, software, or a combination of hardware and software. Software components may be in the form of computer-readable program code stored in a computer-readable storage medium such as memory, mass storage device, or removable storage device. For example, a computer-readable medium may comprise computer-readable code for performing the function of a particular component. Likewise, computer memory may be configured to include one or more components, which may then be executed by a processor. Components may be implemented separately in multiple modules or together in a single module.

The description above includes several details that are exemplary and should not be construed as limiting. For example, most of the description only mentions a single network element and a single network manager. The invention does not exclude having several network elements and several network managers. The present invention provides a simple mechanism to communicate changes in configuration information to upper layers in the network by buffering configuration and state data changes in a network element for a predefined time interval and reporting the changes in one transaction. It is clear to a person skilled in the art that the invention is not restricted only to the examples presented above, but the invention may vary within the limits of the claims presented hereafter. Some possible embodiments of the invention are described in the dependent claims, and they are not to be considered to restrict the scope of protection of the invention as such.

1. A method for communicating configuration management notifications from a network element to a network manager in a packet-switched network, comprising:
storing in the network element a first set of configuration information of said network element at a first time instant,
waiting for a time interval,
storing in the network element a second set of configuration information of said network element at a second time instant,
comparing the first and the second set of configuration information in order to determine changes in the configuration information between the first and the second time instant, and
transmitting said changes to the network manager through a communication connection by using a file-based configuration protocol.

2. A method according to claim 1, wherein the method comprises setting the time interval.

3. A method according to claim 2, wherein said setting the time interval is performed by the network manager through a communication connection.

4. A method according to claim 1, wherein the method comprises:
waiting for the time interval,
storing in the network element a third set of configuration information of said network element at a third time instant,
comparing the second and the third set of configuration information in order to determine changes in the configuration information between the second and the third time instant, and
transmitting said changes to the network manager through a communication connection by using a file-based configuration protocol.

5. A method according to claim 4, wherein the method comprises changing the time interval.

6. A method according to claim 1, wherein the method comprises:
accessing the network element through a local management interface, and
changing configuration information of the network element.

7. A method according to claim 1, wherein the method comprises updating a configuration database in the network manager based on the received changes.

8. A method according to claim 1, wherein the method comprises setting up a filter for configuration information of the network element, the filter defining rules to select which changes in the configuration information are to be communicated to the network manager during the transmitting step.

9. A method according to claim 1, wherein the file-based configuration protocol is the Network Configuration Protocol (NETCONF).

10. A network element for communicating configuration management notifications to a network manager in a packet-switched network, comprising:
a timer for scheduling operations, the timer having a time interval,
means for storing configuration information of the network element at time instants scheduled by the timer,
means for comparing the stored configuration information in order to determine changes in the configuration information between the time instants, and
means for transmitting the changes to the network manager through a communication connection by using a file-based configuration protocol.

11. A network element according to claim 10, wherein the network element comprises a local management interface for allowing local access to configuration information.

12. A system for communicating configuration management notifications from a network element to a network manager in a packet-switched network, comprising:
at the network element
a timer for scheduling operations, the timer having a time interval,
means for storing configuration information of the network element at time instants scheduled by the timer,
means for comparing the stored configuration information in order to determine changes in the configuration information between the time instants, and
means for transmitting the changes to the network manager through a communication connection by using a file-based configuration protocol;
at the network manager
means for receiving the changes in configuration information by using a file-based configuration protocol.

13. A system according to claim 12, wherein the network manager comprises means for setting the time interval of the timer.

14. A system according to claim 12, wherein the network manager comprises a configuration database and means for updating said configuration database based on the received changes.

15. A system according to claim 12, wherein the network manager comprises means for setting up a filter for configuration information of the network element, the filter defining rules to select which changes in the configuration information are to be communicated to the network manager during the transmitting step.

16. A system according to claim 12, wherein the network element comprises a local management interface for allowing local access to configuration information.

17. A computer program product comprising program code means stored on a computer-readable medium for performing the method of claim 1 when said program is run on a computer.
